(19) United States
(12) Patent Application Publication
(10) Pub. No.: US 2002/0040078 A1
(43) Pub. Date: Apr. 4, 2002

(54) Use of acetalized vinyl alcohol polymers as thickeners

(75) Inventors: Bernd Kayser, Burghausen (DE); Andreas Bacher, Burghausen (DE); Werner Bauer, Winhoring (DE); Ulf Dietrich, Altotting (DE); Marion Schmitz, Burghausen (DE); Harald Zeh, Burghausen (DE); Theo Mayer, Julbach (DE)

Correspondence Address: WILLIAM G. CONGER, Brooks & Kushman P.C., 1000 Town Center, 22nd Floor, Southfield, MI, 48075-1351, US

(73) Assignee: Wacker-Chemie GmbH, Munchen (DE)

(21) Appl. No.: 09/925,915

(22) Filed: Aug. 9, 2001

(30) Foreign Application Priority Data
Aug. 17, 2000 (DE) 100 40 171.6

(51) Int. Cl. C08L 29/04; C04B 7/00

(52) U.S. Cl. 524/4; 524/61; 524/503; 524/557; 106/802

(57) ABSTRACT

The invention relates to the use of acetalized vinyl alcohol polymers with a molecular weight Mw greater than 100 000 as thickeners, the thickeners being obtained by acetalizing partially or fully hydrolyzed vinyl acetate homopolymers, or partially or fully hydrolyzed vinyl acetate copolymers which, besides vinyl acetate units, also contain comonomer units which derive from one or more comonomers selected from the group consisting of 1-(C₁₋₅) alkylvinyl esters of C₁₋₅ carboxylic acids, allyl esters, vinyl esters of alpha-branched C₁₋₁₂ carboxylic acids, and C₁₋₈-alkyl (meth)acrylates.

### BACKGROUND OF THE INVENTION

1. Field of the Invention

The invention relates to the use of acetalized vinyl alcohol polymers as thickeners, in particular in compositions used in the building trades.

2. Background Art

It is standard practice in the construction industry to use rheological auxiliaries in a variety of building materials. The theological auxiliaries serve primarily to improve workability and water-retention properties. Additives of this type can also be used to adjust the property profile of the construction material to a desired performance profile. Thickening additives which have been used are primarily water-soluble polymers based on non-ionic cellulose ethers, such as methyl cellulose, hydroxyethyl cellulose, methyl hydroxyethyl cellulose, or hydroxypropyl cellulose. Despite the small amounts used, the cellulose ether is the third most expensive raw material of a cement-type construction adhesive, after the redispersible polymer powder and the cement. The only method of preparing methyl celluloses industrially is the reaction of alkali celluloses with methyl chloride, which creates toxicological concerns, in the presence or absence of organic solvents. Complicated purification steps follow the reaction, for example to remove sodium chloride, which may otherwise lead to corrosion problems in the construction sector.

Cellulose ether thickeners compete, in particular, with entirely synthetic polymers such as associative polyurethane thickeners, polyacrylates, polyimines, polyamides, and also with naturally occurring polymers, such as agar agar, tragacanth, carrageen, gum arabic, alginates, starch, gelatine, and casein. There have hitherto been no alternatives to cellulose ether for workability and water-retention requirements in cement-type systems with high pH and high electrolyte content. A disadvantage of the cellulose ethers usually used in cement-type construction applications, in particular hydroxyethyl methyl cellulose, is that there is sometimes a considerable delay in cement setting. Although polyvinyl alcohols are known constituents of cement-type compositions, they have been used only in a relatively low-molecular-weight form which is incapable of producing a thickening effect. Although their thickening ability would be better in a higher molecular weight form, difficulties then arise due to low cold-water solubility and the poor workability properties associated with this low solubility.

U.S. Pat. No. 5,565,027 discloses polyvinyl alcohols modified with hydroxyaldehydes which are used as cement plasticizers in cement-type systems. Japanese published application JP-A 11-71150 describes vinyl alcohol homo- and copolymers acetalized with unsubstituted or substituted aldehydes as an additive for cement compositions, for improving their compressibility. Japanese published application JP-A 59-78963 proposes improving the adhesion and the surface properties of thin render coatings by mixing the cement-containing renders with methyl cellulose and with a polyvinyl alcohol which is substituted by both hydrophobic groups and by anionic, hydrophilic groups. The hydrophobic groups are introduced by means of copolymerization with hydrophobic comonomers or acetalization with aliphatic monoaldehydes, while the hydrophilic groups are introduced by way of copolymerization with vinylsulfonic acid or by sulfonation. German published application DE-A 3115601 describes the use of acetoacetylated polyvinyl alcohol as a binder in coating compositions and adhesives, recommending the use of conventional thickeners, such as cellulose ether, to improve the Theological properties of these compositions.

### SUMMARY OF THE INVENTION

It was an object of the invention to provide an entirely synthetic water-soluble polymer which acts as a thickener in formulations used in civil engineering, and in particular in cement-type formulations, and which produces excellent workability properties and mechanical properties, but does not have the abovementioned disadvantages.

### DETAILED DESCRIPTION OF THE PREFERRED EMBODIMENT(S)

The invention provides the use of acetalized vinyl alcohol polymers with a molecular weight Mw greater than 100,000 as thickeners, the thickeners being obtained by acetalizing partially or fully hydrolyzed vinyl acetate homopolymers, by or by acetalizing partially or fully hydrolyzed vinyl acetate copolymers which, besides vinyl acetate units, also contain comonomer units derived from one or more comonomers selected from the group consisting of 1-(C₁₋₅) alkylvinyl esters of C₁₋₅ carboxylic acids, allyl esters, vinyl esters of alpha-branched C₅₋₁₂ carboxylic acids, and C₁₋₁₈-alkyl (meth)acrylates. It should be noted that in the description of polymers herein, reference may be made to the monomers from which the polymer is derived, while in reality, the monomer no longer exists in the same form in the polymer. Such terminology is widely used by those skilled in the art.

The degree of hydrolysis of the partially or fully hydrolyzed vinyl acetate homopolymers or vinyl acetate copolymers is generally from 75 to 100 mol %. In the case of “fully hydrolyzed” vinyl alcohol polymers the degree of hydrolysis is preferably from 97.5 to 100 mol %, more preferably from 98 to 99.5 mol %, and in the case of partially hydrolyzed vinyl alcohol polymers it is preferably from 80 to 95 mol %, more preferably from 86 to 90 mol %. In the case of vinyl acetate copolymers, the proportion of comonomer units is from 0.1 to 50% by weight, preferably from 0.3 to 15% by weight, more preferably from 0.5 to 6% by weight, based in each case on the total weight of the vinyl acetate copolymer.

The preferred 1-alkylvinyl ester is isopropenyl acetate. Preferred vinyl esters of alpha-branched carboxylic acids are those of alpha-branched carboxylic acids having from 9 to 11 carbon atoms, and particular preference is given to vinyl esters of alpha-branched carboxylic acids having 10 carbon atoms (VeoVa10, trade name of Shell). Preferred acrylic and methacrylic esters are those of C₁₋₁₀ alcohols. Particular preference is given to methyl acrylate, ethyl acrylate, 2-ethylhexyl acrylate, 2-ethylhexyl methacrylate, and methyl methacrylate. Where appropriate, from 0.05 to 2% by weight of auxiliary monomers, based on the total weight of the monomer mixture, may also be copolymerized. Examples of auxiliary monomers are ethylenically unsaturated mono- or dicarboxylic acids, preferably acrylic acid, methacrylic acid, fumaric acid, crotonic acid, or maleic acid; ethylenically unsaturated carboxamides and ethylenically unsaturated nitriles, preferably acrylamide or acrylonitrile; cyclic carboxamides, such as N-vinylpyrrolidone and N-vinyl-ε-caprolactam, and ethylenically unsaturated carboxylic anhydrides, preferably maleic anhydride.

Particular preference is given to vinyl acetate copolymers having from 0.3 to 15% by weight of isopropenyl acetate vinyl esters of alpha-branched carboxylic acids having from 9 to 11 carbon atoms, or methyl, ethyl or butyl acrylate(s). Particular preference is also given to those copolymers having from 0.3 to 15% by weight of isopropenyl acetate units and from 0.3 to 15% by weight of units of vinyl esters of alpha-branched carboxylic acids having from 9 to 11 carbon atoms. Finally, particular preference is given to vinyl alcohol copolymers having from 0.5 to 6% by weight of isopropenyl acetate, from 0.5 to 6% by weight of vinyl esters of alpha-branched carboxylic acids having 10 carbon atoms (VeoVa10), and from 0.5 to 6% by weight of methyl acrylate; and also to vinyl alcohol copolymers having from 0.5 to 6% by weight of isopropenyl acetate, from 0.5 to 6% by weight of 2-ethylhexyl methacrylate, and from 0.5 to 6% by weight of methyl acrylate.

For acetalization, the partially or fully hydrolyzed vinyl acetate homo- or copolymers are reacted with aliphatic or aromatic aldehydes, preferably having from 1 to 10 carbon atoms, unsubstituted or having one or more substituents selected from hydroxyl, carboxyl, sulfonate, ammonium and aldehyde radicals. Where appropriate, use may also be made of masked aldehydes, for example in the form of hemiacetals or acetals, or aldehydes having a protective group. Preference is given to formaldehyde, acetaldehyde, benzaldehyde, glyoxylic acid, and glyceraldehyde. The degree of acetalization, i.e. the degree of protection of the free hydroxyl groups in the hydrolyzed vinyl acetate polymers, is from 0.5 to 100 mol %, preferably from 0.5 to 70 mol %, particularly preferably from 0.5 to 20 mol %.

The vinyl acetate homo- and copolymers may be prepared by known processes, such as bulk, solution, suspension or emulsion polymerization. Solution polymerization preferably takes place in alcoholic solution, for example in methanol, ethanol or isopropanol. Suspension polymerization and emulsion polymerization are generally carried out in an aqueous medium. The polymerization is preferably takes place at a temperature of from 5 to 90° C. with free-radical initiation by adding initiators conventionally used for the respective polymerization process. In the case of the vinyl acetate copolymers, the vinyl acetate units are introduced into the copolymer by copolymerization of vinyl acetate, the acetate radicals being hydrolyzed in a subsequent hydrolysis step in the same manner as other hydrolyzable monomer units. The molecular weight may be adjusted in the conventional manner by adding regulators, i.e. chain transfer agents, by varying the solvent content, by varying the initiator concentration, or by varying the temperature, or by combinations of these methods. After completion of the polymerization, solvent is distilled off, where appropriate, or the polymer may be isolated from the aqueous phase by filtration.

The hydrolysis takes place in the usual manner under alkaline or acidic conditions, by appropriate addition of base or acid. The vinyl acetate copolymer to be hydrolyzed is preferably dissolved in alcohol such as methanol, at a solids content of from 5 to 50%. The hydrolysis is preferably carried out under basic conditions, for example by adding NaOH, KOH, or NaHCO₃. The resultant vinyl alcohol copolymer may be isolated from the reaction mixture by filtration or by removal of the solvent mixture by distillation. It is also possible to obtain an aqueous solution by adding water, advantageously in the form of superheated steam, during the distillative removal of the organic solvents.

For acetalization, the partially or fully hydrolyzed vinyl acetate homo- or copolymers are preferably dissolved in an aqueous medium. A solids content of from 5 to 30% is usually set for the aqueous solution. The acetalization takes place in the presence of acidic catalysts such as hydrochloric acid, sulfuric acid, or phosphoric acid. The pH of the solution is preferably adjusted to less than 4 by adding 20% strength hydrochloric acid.

After addition of the catalyst, the acetalization reaction is initiated at a temperature of from 0° C. to 100° C. by adding the aldehyde, and is carried out over a period of from 1 to 10 hours. Since the acetalization proceeds to almost full conversion, the amount to be added can be determined by simple stoichiometric calculation. The mixture is then neutralized by adding base, preferably NaOH, and the product is precipitated as solid by dropwise addition into a solvent, preferably an alcohol such as methanol. Where appropriate, the aqueous solution may also be spray-dried. Work-up continues with a drying step and a grinding step. Grinding generally proceeds until the resultant average particle size is less than 1 mm, preferably less than 200 μm.

The thickener may be used as an aqueous solution or in powder form, or as an additive in aqueous polymer dispersions or in water-redispersible polymer powders. It may be used alone or in admixture with other rheology additives. The amount of the thickener generally used is from 0.01 to 20% by weight of thickener composition (as solids) based on the total weight of the composition to be thickened. The thickener is suitable for use as a thickener in any sector where rheological auxiliaries are used, for example as a thickener in cosmetics, in the pharmaceutical sector, in water-based silicone emulsions, in silicone oils, in coating compositions such as emulsion paints or textile coatings, as a thickener in adhesive compositions, or as a thickener in construction applications, either in hydraulically setting compositions or in non-hydraulically setting compositions, for example in concrete, cement mortar, lime mortar, or gypsum mortar. There are also further applications in water-containing mixes which currently use cellulose ethers and starch ethers as thickeners. Particular preference is given to construction applications. Very particular preference is given to cement-type construction applications, such as cement-type construction adhesives (tile adhesives), cement-type dry mortars, cement-type flowable compositions, cement-type renders, and cement-type exterior insulation system adhesives, and cement-type non-shrink grouts.

Typical mixes for cement-type construction adhesives comprise from 5 to 80% by weight of cement, from 5 to 80% by weight of fillers such as quartz sand, calcium carbonate or talc, from 0.5 to 60% by weight of polymer dispersion or redispersible polymer powder, from 0.1 to 5% by weight of thickeners, and where appropriate, other additives for improving stability, workability, open time, and water resistance. The data given here in % by weight are always based on 100% by weight of dry material of the mix and give a total of 100% by weight. The cement-containing construction adhesive mixes mentioned are used especially as tile adhesives for tiles of any type (earthenware, stoneware, porcelain, ceramics, natural tiles), indoors or outdoors, and are mixed with the appropriate amount of water prior to use.

The thickeners of the invention are also suitable for use in cement-free construction mixes, for example with the appropriate amount of gypsum or water glass as inorganic binders, and preferably in gypsum-containing compositions, such as gypsum renders or gypsum troweling compositions. The cement-free mixes are used especially in troweling compositions, tile adhesives, exterior insulation system adhesives, renders, or paints. Typical mixes for gypsum formulations comprise from 15 to 96% by weight of calcium sulfate, from 3 to 80% by weight of fillers, such as quartz sand, calcium carbonate or talc, from 0 to 5% by weight of hydrated lime, from 0 to 5% by weight of polymer dispersion or polymer powder, and also from 0.01 to 3% by weight of thickeners, and, where appropriate, other additives for improving stability, workability, open time and water resistance. The data in % by weight are always based on 100% by weight of dry material of the mix, and give a total of 100% by weight.

In cement-type construction compositions such as tile adhesives, the thickeners of the invention are found to give excellent workability and mechanical properties in the cement-type composition even without addition of other rheological additives such as methyl hydroxyethyl cellulose. Until now only a partial replacement of cellulose ethers in cement-type construction formulations has been possible, for example by starch thickeners or water-soluble polyacrylates, but with considerable loss of technical qualities from the construction composition. Using the thickener of the invention, it is possible to replace up to 100% of cellulose ethers in the cement-type application without any sacrifice in quality.

The examples below give further illustration of the invention.

### EXAMPLE 1

1,000 g of a 6.6% strength aqueous solution of polyvinyl alcohol (degree of hydrolysis: 98 mol %) forms an initial charge in a laboratory apparatus of 2.5 liter capacity, fitted with a thermostat. The reactor was controlled to 30° C. and a pH of 3.5 was set using 10% strength hydrochloric acid. 3.3 g of acetaldehyde were metered in over a period of 1 hour. The mixture was held for 2 more hours at this temperature and then cooled. It was then neutralized using 10% strength sodium hydroxide solution, and the solution was added dropwise into a large excess of methanol, whereupon the vinyl alcohol polymer precipitated. The result was a partially acetalized (10 mol % based on OH groups) polyvinyl alcohol which can be used as a solution or in powder form.

### EXAMPLE 2

Example 1 was repeated, but 1.6 g of benzaldehyde (2 mol %, based on OH groups) were added to the polyvinyl alcohol solution.

### EXAMPLE 3

Example 1 was repeated, but 5.5 g of a 50% strength aqueous glyoxylic acid solution (5 mol % based on OH groups) were added to the polyvinyl alcohol solution.

### EXAMPLE 4

Example 1 was repeated, but 7.26 g of glyceraldehyde (10 mol % based on OH groups) were added to the polyvinyl alcohol solution.

### Comparative Example 5

Commercially available hydroxyethyl methyl cellulose with a Höppler viscosity of 6,000 mPaBPs (DIN 53015, 2% by weight aqueous solution).

### Comparative Example 6

Commercially available, fully hydrolyzed polyvinyl alcohol with a degree of hydrolysis of 99.5 mol % and with a molecular weight Mw greater than 200,000.

### Testing of Thickeners

### The Thickeners were Tested in the Following Formulation

55.2 parts by weight of quartz sand No. 9a (0.1-0.4 mm),

43.0 parts by weight of cement 42.5 (Rohrdorfer),

1.5 parts by weight of redispersible polymer powder (Vinnapas™ RE 530 Z),

0.7 part by weight of thickener.

The dry mixture was mixed with the amount of water given in table 1, the mixture was allowed to stand for 5 minutes, and then tested. The test results are give in Table 1.

### Test Methods

### Determination of Plasticity

The plasticity of the mixture was determined qualitatively by stirring the formulation. Results were evaluated on a grading scale from 1 to 6, grade 1 being the best.

### Determination of Wetting Properties

To determine wetting properties, the formulation was applied to a fiber-reinforced concrete panel using a serrated trowel, and the wetting of the panel was assessed qualitatively. Results were evaluated on a grading scale from 1 to 6, grade 1 being the best.

### Determination of Quality of Bead Production

The formulation was applied to a fiber-reinforced concrete panel using a serrated trowel, and the quality of the resultant beads was assessed qualitatively. Results were evaluated on a grading scale from 1 to 6, grade 1 being the best.

### Determination of Water Retention

Water retention was determined to DIN 18555 Part 7. Table 1 gives the proportion of water which remained in the formulation.

### Determination of Break-out

The tile adhesive formulation was applied to a fiber-reinforced concrete panel, onto which a tile (5 cm×5 cm) was laid after 20 minutes and which was loaded with a weight of 2 kg for 30 seconds. After a further 60 minutes, the tile was removed and the percentage of the reverse side of the tile still covered with adhesive was determined.

### Determination of Stability (Slip Test)

For the slip test, a tile (15 cm×15 cm) was placed into the tile adhesive formulation and was loaded with 5 kg for 30 seconds, and the sample structure was placed vertically. The upper edge of the tile was then loaded with weights, in each case for 30 seconds, and the weight at which the tile slips was determined.

### Determination of Cement-setting Performance

Cement-setting performance was determined using a heat sensor in the tile adhesive formulation. The time taken for setting to begin was determined, and the retardation (values greater than 100) or the acceleration (values less than 100) of setting was determined relative to that of a formulation with no thickener.

### Discussion of Test Results

The test results show that the thickeners of the invention (Examples 1 to 4), based on partially acetalized vinyl alcohol polymers, give markedly better workability (plasticity, wetting, bead quality) than conventional polyvinyl alcohol (comparative example 6), significantly better thickening effect (break-out, water retention), and markedly accelerated setting performance (chemical setting).

Compared with conventional thickeners based on cellulose ethers (comparative example 5), the partially acetalized vinyl alcohol polymers give markedly better workability (plasticity, wetting, bead quality) and markedly accelerated setting performance (cement setting).

TABLE 1

| | Wa- | | | Bead | | Water | | |
|---|---|---|---|---|---|---|---|---|
| Exam- | ter | Plas- | Wet- | qual- | Break- | Reten- | | Cement |
| ple | (g) | ticity | ting | ity | out | tion | Slip | setting |
| 1 | 22.8 | 1 | 1 | 1.5 | 72 | 98.7 | 200 | 94 |
| 2 | 22.9 | 1 | 1 | 1.5 | 90 | 98.2 | 200 | 96 |
| 3 | 23.2 | 1 | 2 | 1 | 74 | 98.5 | 800 | 96 |
| 4 | 22.6 | 1 | 1 | 1 | 70 | 98 | 200 | 90 |
| Comp. | 23 | 2.5 | 2.5 | 1.5 | 98 | 98.5 | 200 | 185 |
| Ex. 5 | | | | | | | | |
| Comp. | 22.9 | 3.5 | 4.5 | 5 | 25 | 96.5 | 400 | 120 |
| Ex. 6 | | | | | | | | |

The testing of the thickeners in gypsum-containing mixes (gypsum renders) was carried out with the following formulation:

| | | |
|---|---|---|
| Calcium sulfate (Primoplast - Hilliges Gipswerk) | 700 | g |
| Quartz sand (No. 7; 0.2-0.7 mm) | 237.6 | g |
| Perlite light-weight filler (3 mm) | 25 | g |
| Hydrated lime (Walhalla) | 35 | g |
| Retarder (Retardan, aminobutyraldehyde condensate) | 0.4 | g |
| Thickener | 2 | g |

### Test Methods

The test results are given in Table 2.

### Determination of Air Pore Content

Air pore content was determined to DIN 18555 Part 2.

### Determination of Water Retention

Water retention was determined to DIN 18555 Part 7.

### Plasticity

The plasticity of the mixture was determined qualitatively by stirring the formulation. The results were evaluated on a grading scale from 1 to 6, grade 1 being the best.

### Stability

The stability of the formulation was determined qualitatively by passing a trowel through the mixture. The results were evaluated on a grading scale from 1 to 6, grade 1 being the best.

### Post-thickening

Post-thickening of the formulation was assessed qualitatively after a waiting time of 5 minutes. The results were evaluated on a grading scale from 1 to 6, grade 1 being the best.

### Start of Setting (SS), Completion of Setting (CS)

The time taken for setting to begin was determined by means of a needle repeatedly inserted into the formulation. The start of setting is the juncture at which the depth of insertion of the needle begins to be smaller, with the same force exerted. Once the setting had been completed, it was no longer possible to insert the needle by exerting the same force.

### Felting Time

The formulation was troweled onto a brick wall and smoothed with a timber batten after a waiting time. The render was then felted using a moistened sponge. The felting time is the time from which felting can be begun without breaking up the render (measured from application of the formulation).

### Slump

The formulation is placed in a settling funnel on a slump table to DIN 1060 Part 3, and the slump of the mixture is measured 1 minute after removing the funnel, and also after using 15 impacts to vibrate the specimen.

### Shrinkage

Test specimens are prepared from the mixture, and the change in length of the longitudinal axis of the prisms is determined after 28 days using a test device to DIN 52450.

TABLE 2

| | H₂O | H₂O retention | Air pores | Slump | Slump after |
|---|---|---|---|---|---|
| Thickener | (g) | (%) | (%) | (cm) | vibration (cm) |
| Ex. 1 | 440 | 98.1 | 12.3 | 10.2 | 16.4 |
| C. ex. 5 | 420 | 98.9 | 8.8 | 10.0 | 15.5 |

| | | | | | | Shrink- | Felting |
|---|---|---|---|---|---|---|---|
| | SS | CS | Post- | Plas- | | age | time |
| Thickener | (min) | (min) | thickening | ticity | Stability | (mm/m) | (min) |
| Ex. 1 | 105 | 125 | 1 | 1 | 1.5 | 0.232 | 50 |
| C. ex. 5 | 100 | 120 | 1 | 2 | 3.0 | 0.253 | 55 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. The terms “a” and “an” mean “one or more” unless otherwise specified. The term “thickening” means “increasing the viscosity of”. Unless specified otherwise, mixtures of thickeners are contemplated by the claims.

What is claimed is:

1. A process for thickening a liquid composition, said process comprising adding to said liquid composition or to a mixture used to prepare said liquid composition, an effective thickening amount of a thickener comprising an acetalized vinyl alcohol polymer with a molecular weight Mw greater than 100,000, said acetalized vinyl alcohol polymer comprising at least one of an acetalized partially or fully hydrolyzed vinyl acetate homopolymer, or an acetalized partially or fully hydrolyzed vinyl acetate copolymer which besides vinyl acetate units also contains comonomer units derived from one or more comonomers from the group of 1-(C₁₋₅)alkylvinyl esters of C₁₋₅ carboxylic acids, allyl esters, vinyl esters of alpha-branched C₅₋₁₂ carboxylic acids, and C₁₋₁₈-alkyl (meth)acrylates.

2. The process of claim 1, wherein said partially or fully hydrolyzed vinyl acetate homo- or copolymers have a degree of hydrolysis of from 75 to 100 mol %, and have been acetalized with aliphatic or aromatic aldehydes to a degree of acetalization of from 0.5 to 100 mol %.

3. The process of claim 2, wherein the aliphatic or aromatic aldehydes are substituted by one or more substituents selected from hydroxyl, carboxyl, sulfonate, ammonium, and aldehyde radicals.

4. The process of claim 1, wherein the partially or fully hydrolyzed vinyl acetate homo- or copolymers have been acetalized with one or more aldehydes selected from formaldehyde, acetaldehyde, benzaldehyde, glyoxylic acid, and glyceraldehyde.

5. The process of claim 1, wherein the partially or fully hydrolyzed vinyl acetate copolymers contain, besides vinyl acetate units, comonomer units of one or more comonomers selected from isopropenyl acetate, vinyl esters of alpha-branched C₉₋₁₁ carboxylic acids, and C₁₋₁₀-alkyl (meth)acrylates.

6. The process of claim 6, wherein the thickeners are obtained by acetalization of partially or fully hydrolyzed vinyl acetate copolymers containing moieties derived from comonomers selected from copolymers having from 0.3 to 15% by weight of any of isopropenyl acetate, vinyl esters of alpha-branched C₉₋₁₁ carboxylic acids, and C₁₋₁₀ alkylmethacrylates.

7. The process of claim 5, wherein the proportion of each comonomer unit other than vinyl acetate is from 0.3 to 15% by weight, based on the total weight of the partially or fully hydrolyzed vinyl acetate copolymer.

8. The process of claim 6, wherein the thickeners are obtained by acetalization of partially or fully hydrolyzed vinyl acetate copolymers selected from:
copolymers having from 0.3 to 15% by weight of any of isopropenyl acetate, vinyl esters of alpha-branched C₉₋₁₁ carboxylic acids, methyl, ethyl, butyl or 2-ethylhexyl acrylate(s) or 2-ethylhexyl methacrylate;
copolymers having from 0.3 to 15% by weight of isopropenyl acetate units and from 0.3 to 15% by weight of vinyl esters of alpha-branched C₉₋₁₁ carboxylic acids;
copolymers having from 0.5 to 6% by weight of isopropenyl acetate, from 0.5 to 6% by weight of vinyl esters of alpha-branched C₁₀ carboxylic acids, and from 0.5 to 6% by weight of methyl acrylate; and
copolymers having from 0.5 to 6% by weight of isopropenyl acetate, from 0.5 to 6% by weight of 2-ethylhexyl methacrylate, and from 0.5 to 6% by weight of methyl acrylate.

9. The process of claim 1, wherein the thickeners are in aqueous solution, in powder form, as an additive in aqueous polymer dispersions or in redispersible polymer powders, in amounts of from 0.01 to 20% by weight of thickener (as solid), based on the total weight of the composition to be thickened, wherein the composition to be thickened is selected from cosmetic compositions, pharmaceutical compositions, water-based silicone emulsions, silicone oils, coating compositions, adhesive compositions, or construction compositions.

10. The process of claim 9, wherein said construction composition is a hydraulically setting or non-hydraulically setting composition.

11. The process of claim 10, wherein said construction composition comprises a cement-based construction adhesive, a cement-based dry mortar, a cement-based flowable composition, a cement-based render, or a cement-based exterior insulation system adhesive, or a cement-based non-shrink grout.

12. The process of claim 10, wherein said construction composition comprises a gypsum-containing composition.

13. The process of claim 10, wherein said gypsum-containing composition is a render or a troweling composition.

14. The process of claim 10, wherein said composition comprises a cement-free troweling composition, a render, a tile adhesive, or an exterior insulation system adhesive.

15. The process of claim 10, wherein said construction composition further comprises at least one water-redispersible polymer powder.

16. A hydraulically setting or non-hydraulically setting composition thickened by the process of claim 1.

17. A hydraulically settable or non-hydraulically settable composition, comprising an effective, thickening amount of a thickener component comprising an acetalized vinyl alcohol polymer with a molecular weight Mw greater than 100,000 prepared by acetalizing partially or fully hydrolyzed vinyl acetate homopolymer, or by acetalizing a partially or fully hydrolyzed vinyl acetate copolymer which besides vinyl acetate units also contains comonomer units derived from one or more comonomers from the group of 1-(C₁₋₅)alkylvinyl esters of C₁₋₅ carboxylic acids, allyl esters, vinyl esters of alpha-branched C₅₋₁₂ carboxylic acids, and C₁₋₁₈-alkyl (meth)acrylates.

18. The composition of claim 17 which is a cement-based composition.

19. The composition of claim 17, which is a concrete, a cement mortar, a lime mortar, or a gypsum mortar.

20. The composition of claim 17 which is a tile adhesive, a render, or an exterior insulation system adhesive.

21. The composition of claim 17, wherein said thickener component comprises from 0.1 to 20 weight percent of the total composition, based on solids.

22. The composition of claim 21 wherein said composition is a cement-type composition containing from 0.1 to 5 weight percent of said thickener component.
